(19) United States
(12) Patent Application Publication
(10) Pub. No.: US 2024/0006638 A1
(43) Pub. Date: Jan. 4, 2024

(54) FUEL CELL SYSTEM

(71) Applicant: SUBARU CORPORATION, Tokyo (JP)

(72) Inventor: Tomohiro ABE, Tokyo (JP)

(21) Appl. No.: 18/329,752

(22) Filed: Jun. 6, 2023

(30) Foreign Application Priority Data
Jun. 29, 2022 (JP) 2022-104261

(51) Int. Cl. H01M 8/04746; H01M 8/0432; H01M 8/04492; H01M 8/249

(52) U.S. Cl. CPC H01M 8/04746; H01M 8/0432; H01M 8/04492; H01M 8/249

(57) ABSTRACT

A fuel cell system includes a fuel cell stack, a control device, and a flow regulating mechanism. The fuel cell stack is divided into multiple sections. Each of the multiple sections is constituted by one or more cells. The control device is configured to manage a state of the one or more cells for each of the multiple sections. The flow regulating mechanism is configured to regulate a flow rate of a fluid circulating through each of the multiple sections, based on the state managed by the control device. The control device is configured to divide the fuel cell stack such that the number of cells in a first section of the multiple sections and the number of cells in a second section of the multiple sections other than the first section differ from each other.

### CROSS-REFERENCE TO RELATED APPLICATIONS

The present application claims priority from Japanese Patent Application No. 2022-104261 filed on Jun. 29, 2022, the entire contents of which are hereby incorporated by reference.

### BACKGROUND

The disclosure relates to a fuel cell system that is applied, for example, to vehicles.

For example, automobiles are used for transportation in modern society, and various vehicles travel on roads daily. In recent years, fuel cells that have less impact on environment have been attracting attention.

In such a fuel cell, hydrogen supplied to one electrode (fuel electrode) and oxygen supplied to the other electrode (air electrode) react to produce electrical energy. To reduce losses and efficiently produce electrical energy, the state of the fuel cell is to be appropriately managed. For example, Japanese Unexamined Patent Application Publication (JP-A) No. 2017-201627 and JP-A No. 2020-198208 each disclose a technique in which, in a fuel cell system including a fuel cell stack of cells, the cells are divided into groups and the impedance of each group is measured to manage the state of the cells.

### SUMMARY

An aspect of the present disclosure provides a fuel cell system. The fuel cell system includes a fuel cell stack, a control device, and a flow regulating mechanism. The fuel cell stack is divided into multiple sections. Each of the multiple sections is constituted by one or more cells. The control device is configured to manage a state of the one or more cells for each of the multiple sections. The flow regulating mechanism is configured to regulate a flow rate of a fluid circulating through each of the multiple sections, based on the state managed by the control device. The control device is configured to divide the fuel cell stack such that the number of cells in a first section of the multiple sections and the number of cells in a second section of the multiple sections other than the first section differ from each other.

An aspect of the present disclosure provides a fuel cell system. The fuel cell system includes a fuel cell stack, circuitry, and a flow regulating mechanism. The fuel cell stack is divided into multiple sections. Each of the multiple sections is constituted by one or more cells. The circuitry is configured to manage a state of the one or more cells for each of the multiple sections. The flow regulating mechanism is configured to regulate a flow rate of a fluid circulating through each of the multiple sections, based on the state managed by the circuitry. The circuitry is configured to divide the fuel cell stack such that the number of cells in a first section of the multiple sections and the number of cells in a second section of the multiple sections other than the first section differ from each other.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is an overall block diagram of a fuel cell system according to a first embodiment;

FIG. 2 is a schematic diagram of a fuel cell stack according to the first embodiment;

FIG. 3 is a block diagram of a control device in the fuel cell system according to the first embodiment;

FIG. 4 is a schematic diagram of an oxidation gas supply system in the fuel cell system according to the first embodiment;

FIG. 5 is a flowchart illustrating a method of state management in the fuel cell system according to the first embodiment;

FIG. 6 is a schematic diagram illustrating an example of how cells are grouped by the control device according to the first embodiment;

FIG. 7 is a schematic diagram illustrating an example of how cells are regrouped by the control device according to the first embodiment;

FIG. 8 is a diagram illustrating an example of how the flow rate of a fluid is regulated by a flow regulating mechanism according to the first embodiment;

FIG. 9 is an overall block diagram of a fuel cell system according to a second embodiment; and

FIG. 10 is an overall block diagram of a fuel cell system according to a modification.

### DETAILED DESCRIPTION

Existing techniques, including those disclosed in JP-A No. 2017-201627 and JP-A No. 2020-198208, do not appropriately meet market needs and have challenges described below.

In the fuel cell systems proposed in JP-A No. 2017-201627 and JP-A No. 2020-198208, the cells are divided into several groups and the impedance of each group is measured to finely manage the state of the fuel cell system. However, the existing techniques, including those disclosed in JP-A No. 2017-201627 and JP-A No. 2020-198208, do not address a suitable way for the entire fuel cell system to divide the cells into groups. That is, there is still much room for improvement in the way of dividing the cells into groups.

The present disclosure has been made in view of such challenges as those described above. It is desirable to provide a fuel cell system in which, in a fuel cell stack of multiple cells, a partial degradation of cell performance and quality can be prevented.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. Components other than those described in detail below may be appropriately supplemented with element technology and components related to known fuel cell systems, including those disclosed in JP-A No. 2017-201627 and JP-A No. 2020-198208.

### First Embodiment

(Fuel Cell System 100)

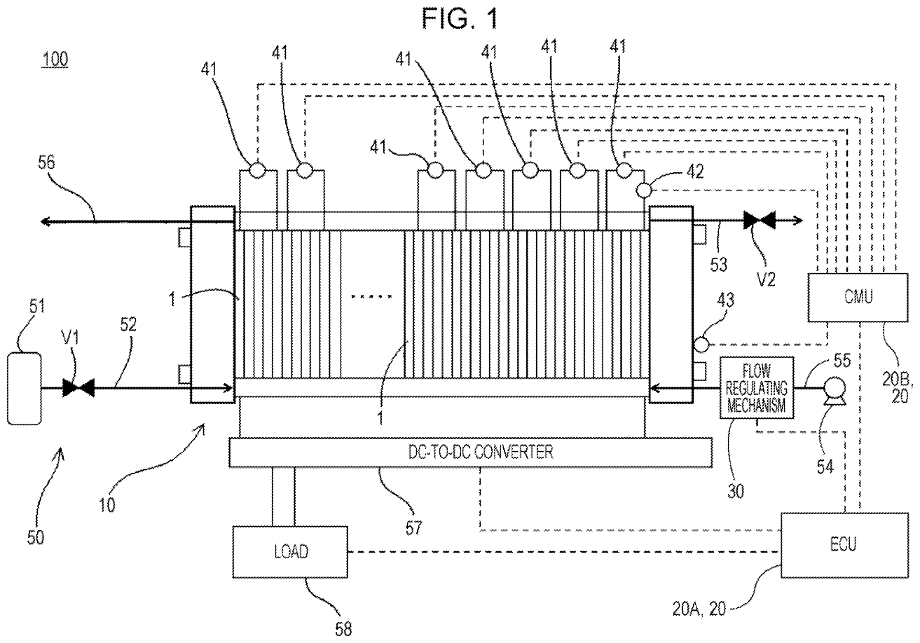

A configuration of a fuel cell system 100 according to an embodiment of the present disclosure will now be described with reference to FIG. 1. The fuel cell system 100 of the present embodiment may be mounted, for example, on a fuel cell vehicle (FCV).

An FCV will be described as an example in which the fuel cell system 100 is used. The present disclosure is also applicable to a stationary fuel cell system for housing facilities, and to a fuel cell system mounted on movable bodies, such as airplanes.

The fuel cell system 100 mounted on an FCV includes a control device 20 (including an electronic control unit (ECU) 20A and other known ECUs) configured to control the vehicle, a fuel cell stack 10 controlled by the control device 20, and a gas supply system 50 configured to supply an anode gas and a cathode gas to the fuel cell stack 10. The fuel cell system 100 of the present embodiment also includes a known cell management unit (CMU) 20B configured to manage the state of the fuel cell stack 10. The control device 20 of the present embodiment configured to control the vehicle may include the ECU 20A and the CMU 20B.

The gas supply system 50 of the present embodiment includes a known hydrogen tank 51 configured to supply a hydrogen gas to an anode electrode side of the fuel cell stack 10, a fuel gas intake pipe 52, and a fuel gas exhaust pipe 53. The gas supply system 50 also includes a known air compressor 54 serving as a cathode gas supply unit configured to supply air to a cathode electrode side of the fuel cell stack 10, an air intake pipe 55, and an air exhaust pipe 56. The flow rates of the cathode gas and the anode gas can be individually regulated by known flow regulating valves V1 to V3 under control of the control device 20.

Although not explained in the description of the present embodiment, the gas supply system 50 may include a known mechanism, such as a humidifier, a hydrogen gas reflux mechanism (not illustrated), or a pressure regulating valve, described in JP-A No. 2017-201627 and JP-A No. 2020-198208. Although the fuel cell stack 10 of the present embodiment includes therein a coolant passage through which a known coolant for cooling the fuel cell stack 10 flows, FIG. 1 does not illustrate the coolant passage and a known coolant circulation system for circulating the coolant through the coolant passage.

As illustrated in FIG. 1, the fuel cell stack 10 of the present embodiment includes cells 1 stacked in the stacking direction. The cells 1 are each constituted by a single fuel cell. As described below, the state of the fuel cell stack 10 is managed by dividing the fuel cell stack 10 into sections, each constituted by one or more cells 1.

Each of the cells 1 constituting the fuel cell stack 10 is, for example, a known polymer electrolyte fuel cell (PEFC). Although the fuel cell stack 10 of the present embodiment is constituted by polymer electrolyte fuel cells, other known fuel cells, such as solid oxide fuel cells, may be used. Each of the cells 1 constituting the fuel cell stack 10 includes a fuel gas passage on one side (anode side) of an electrolyte membrane and an oxidation gas (air) passage on the other side (cathode side) of the electrolyte membrane.

Each of the cells 1 constituting the fuel cell stack 10 is to be supplied with a fuel gas, an oxidation gas, and a coolant (cooling water) for cooling. Accordingly, the fuel cell stack 10 of the present embodiment includes manifolds for distributing or collecting the fluids (fuel gas, oxidation gas, and cooling water) described above.

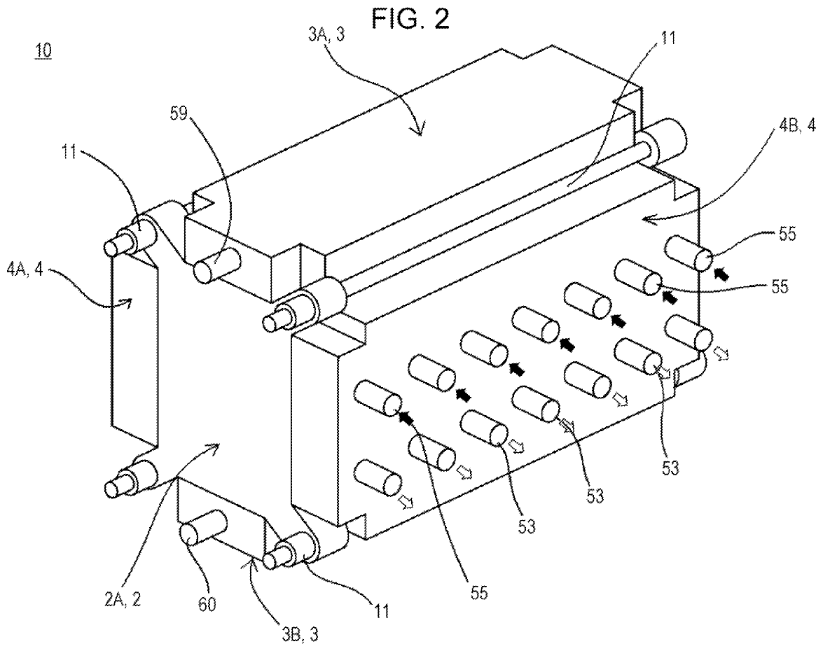

For example, as illustrated in FIG. 2, the fuel cell stack 10 of the present embodiment includes a pair of endplates 2 (a first endplate 2A and a second endplate 2B) disposed at both ends of the stacked cells 1 in the stacking direction, a first manifold 3 disposed in regions of the periphery of the stacked cells 1 and including passages that allow circulation of the cooling water, and a second manifold 4 disposed in other regions of the periphery of the stacked cells 1 and including passages that allow circulation of the fuel gas and the oxidation gas. The pair of endplates 2 is configured to be capable of applying pressure to the cells 1 through known fastening studs 11.

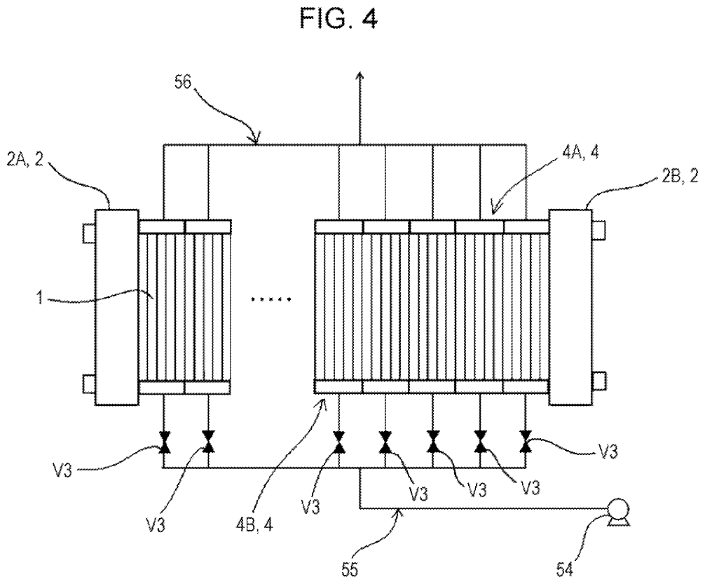

As illustrated in FIG. 4, the second manifold 4 of the present embodiment is also characterized in that the passages of the oxidation gas and the fuel gas each correspond to one group (which may hereinafter be also referred to as “section”) constituted by one or more cells 1. As is understood from FIG. 4, the air intake pipe 55 is divided into branches in such a way that the oxidation gas circulates through each of the groups. The branches of the air intake pipe 55 extending toward the respective groups are each provided with the flow regulating valve V3.

The branches of the air intake pipe 55 are coupled to an inlet-side second manifold 4B whose passages correspond to the respective groups. The oxidation gas supplied to the inlet-side second manifold 4B is supplied to the cathode side of one or more cells 1 in each group, flows out to an outlet-side second manifold 4A whose passages also correspond to the respective groups, and is then joined.

By regulating the degree of opening of the flow regulating valve V3, the control device 20 of the present embodiment can regulate the flow rate of the oxidation gas supplied to each group. The flow regulating valve V3 of the present embodiment thus serves as the flow regulating mechanism 30 (see FIG. 1) that regulates the flow rate of the fluid circulating through each of the groups or sections described above. The flow regulating mechanism 30 is not limited to a known valve mechanism, such as the flow regulating valve V3 described above. The flow regulating mechanism 30 may be a known flow regulator, such as a shutter mechanism capable of opening and closing the passage with a shutter.

In the present embodiment, each branch of the air intake pipe 55 coupled to the inlet-side second manifold 4B is provided with the flow regulating valve V3. However, the configuration is not limited to this. Each branch of the air exhaust pipe 56 coupled to the outlet-side second manifold 4A may be provided with the flow regulating valve V3. The flow regulating valve V3 on the downstream side (i.e., adjacent to the outlet-side second manifold 4A) can also serve as a back pressure valve. The flow regulating valve V3 is thus capable of regulating the pressure as well as regulating the flow rate for the corresponding section.

FIG. 4 illustrates an example in which the flow rate of the oxidation gas supplied to each group is regulated by regulating the degree of opening of the flow regulating valve V3. The flow rate of the fuel gas supplied to each group may be regulated in the same manner as that described above. Each passage of the first manifold 3 (a first manifold 3A and a second manifold 3B) including a cooling water inlet 59 and a cooling water outlet 60 through which the cooling water circulates, may also correspond to one group. The flow rate of the cooling water supplied to each group may be regulated in the same manner as that described above.

The manifolds described above may be manufactured by referring to, for example, JP-A No. 2010-123325 and JP-A No. 2008-41475, each illustrating an example of manufacturing “external manifold”.

The state of power generation of the fuel cell stack 10 is managed by the known CMU 20B. The CMU 20B is a circuit included in the control device 20 of the present embodiment and having the function of detecting the output voltage and the output current of each of the cells 1 constituting the fuel cell stack 10. In other words, the CMU 20B serving as the control device 20 is capable of detecting the output voltage and the output current of each of the cells 1 divided into groups. The voltage value and the current value of each group detected by the CMU 20B may be output, for example, to the ECU 20A.

The control device 20 of the present embodiment (the ECU 20A and the CMU 20B) includes, for example, one or more known memories and one or more central processing units (CPUs) electrically coupled the one or more memories. The one or more CPUs are configured to execute computation in accordance with a control program defined in advance. The control device 20 may include a known read-only memory (ROM) and a known random-access memory (RAM). The ROM is configured to store, in advance, control programs and control data used by the CPU to execute various computations. Various types of data used by the CPU to execute various computations are temporarily written to read from the RAM. The control device 20 of the present embodiment may control the power generation in the fuel cell stack 10, the drive of the gas supply system 50, or the supply of power from a DC-to-DC converter 57 to a known load 58, such as a motor.

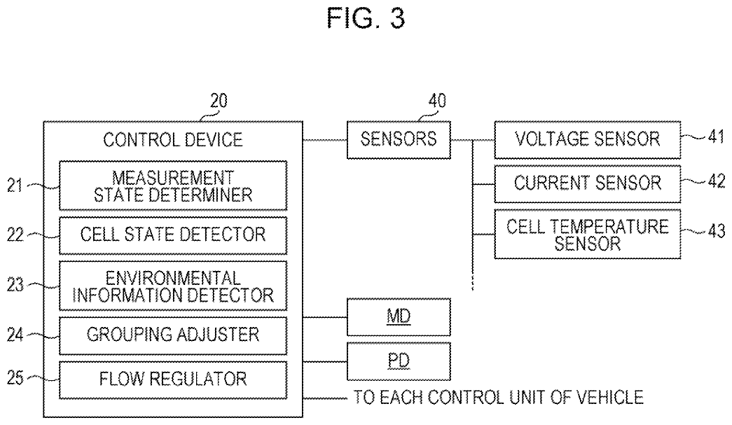

With also reference to FIG. 3, the configuration of the control device 20 in the fuel cell system 100 of the present embodiment will be described. As illustrated in FIG. 3, the control device 20 of the present embodiment includes a measurement state determiner 21, a cell state detector 22, an environmental information detector 23, a grouping adjuster 24, and a flow regulator 25.

The control device 20 has the function of managing, for each section, the state of the cells 1 constituting the fuel cell stack 10. In the control device 20, for example, the grouping adjuster 24 partially increases the number of sections to finely manage and improve the internal state of the fuel cell. This can prevent a partial degradation of performance and quality in the fuel cell stack 10.

The control device 20 makes the number of sections variable in accordance with environmental information and the cell internal state, so that a region having more impact on the level of performance can be finely controlled and a region having less impact on the level of performance can be relatively roughly controlled. This can improve control accuracy in the fuel cell stack 10 and reduce computational load in analyzing the fuel cell stack 10.

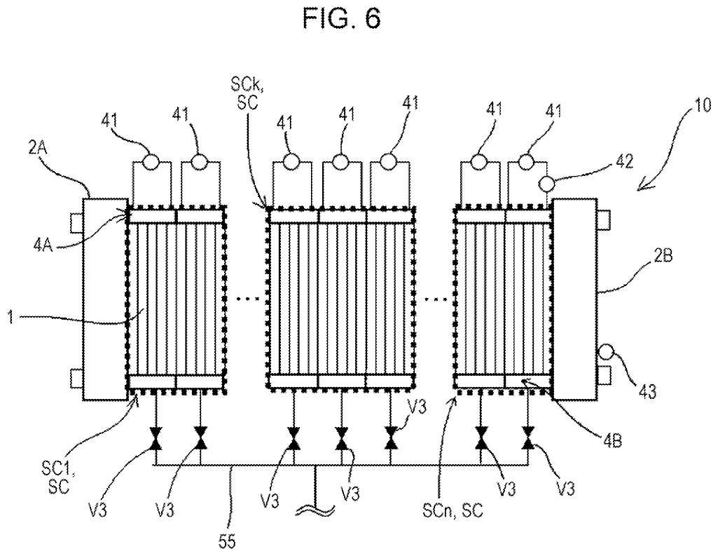

The measurement state determiner 21 has the function of determining the number of sections to be subjected to measurement in the fuel cell stack 10. For example, as is understood from FIG. 4 and FIG. 6, the measurement state determiner 21 can perform grouping in such a way that the number of cells in a first section (e.g., section SC1) of multiple sections SC and the number of cells in a second section (e.g., section SCk) of the multiple sections SC differ from each other. For example, in the example illustrated in FIG. 6, the number of cells in the section SC1 is 10, whereas the number of cells in the section SCk is 15.

In the example illustrated in FIG. 6, the fuel cell stack 10 is divided into n sections, No. 1 to No. n, in order from one end of the fuel cell stack 10, and the k-th section is disposed in the middle of the fuel cell stack 10. The number of sections into which the fuel cell stack 10 is divided can be appropriately set in accordance with the number of cells 1 coupled in series. For example, when the fuel cell stack 10 includes more than 300 cells 1 coupled in series, the fuel cell stack 10 may be divided into about 10 to 20 sections.

The measurement state determiner 21 may define, in advance, an operation point for the fuel cell stack 10 at which the state of power generation tends to vary among sections in the fuel cell stack 10. Then, when the fuel cell stack 10 reaches the operation point, the sections are grouped or regrouped. Examples of the operation point for the fuel cell stack 10 include a cell voltage, an intake temperature of oxidation gas, the amount of power generated by the fuel cell (e.g., during idling or high load operation), and a time point when each of the fluids (oxidation gas, fuel gas, and cooling water) is controlled at a low flow rate.

In the present embodiment, the number of cells 1 may vary from one section to another, as described above. Therefore, in accordance with the state of measurement determined for each section of the fuel cell stack 10, the measurement state determiner 21 determines the measurement frequency and amplitude of impedance, an analysis formula, an equivalent circuit, or measurement conditions by using a known technique. The frequency and amplitude of an alternating waveform (e.g., current) applied to the fuel cell stack 10 for calculating the impedance described above may be basically the same among the sections. When, for example, a composite waveform containing multiple frequencies is applied to the fuel cell stack 10 to identify an intended state of power generation, fast Fourier transform (FFT) analysis is to be performed for each section after measurement to separate the frequencies. Therefore, the frequency and amplitude of an alternating waveform applied to the fuel cell stack 10 may vary from one section to another.

The sampling frequency during measurement may also vary depending on the alternating waveform applied to the fuel cell stack 10. To reduce computational load, for example, a relatively high sampling rate is used when the alternating waveform applied to the fuel cell stack 10 is a high-frequency waveform, whereas a relatively low sampling rate is used when the alternating waveform applied to the fuel cell stack 10 is a low-frequency waveform.

The cell state detector 22 has the function of receiving measurement information from sensors 40 and measuring the state of each section constituting the fuel cell stack 10. Examples of the sensors 40 include, as illustrated in FIG. 1 and FIG. 3, a known voltage sensor 41 capable of measuring the voltage value of each section, a known current sensor 42 capable of measuring the value of current flowing through the fuel cell stack 10, and a known cell temperature sensor 43 capable of measuring the temperature of the fuel cell stack 10. Although FIG. 3 illustrates three sensors, the sensors 40 may include various known sensors mounted on a vehicle, such as a vehicle speed sensor and a global positioning system (GPS) sensor.

The environmental information detector 23 has the function of acquiring environmental information around the FCV, such as temperature and humidity around the fuel cell stack 10, on the basis of known measurement sensors mounted on the FCV. Examples of the measurement sensors include known on-vehicle sensors mounted on the FCV, such as a known outside-air temperature sensor capable of measuring the temperature around the FCV and a known humidity sensor capable of measuring the humidity around the FCV.

The grouping adjuster 24 has the function of dividing the fuel cell stack 10 of the cells 1 into multiple sections (or groups). For example, the grouping adjuster 24 may perform grouping in such a way that the number of cells in a first section of the multiple sections and the number of cells in a second section of the multiple sections differ from each other.

As will be described further below, the grouping adjuster 24 may perform grouping in such a way that the number of cells constituting a middle section (e.g., section SCk in FIG. 6) in the middle of the fuel cell stack 10 and the number of cells constituting each of end sections (e.g., sections SC1 and SCn in FIG. 6) on both sides of the middle section differ from each other. The grouping adjuster 24 may perform grouping in such a way that the number of cells constituting each of the end sections on both sides of the middle section of the fuel cell stack 10 is smaller than the number of cells constituting the middle section.

The flow regulator 25 has the function of regulating, for each of the sections adjusted by the grouping adjuster 24, the flow rate of a fluid (which is oxidation gas in the present example, but may be fuel gas or cooling water) flowing through the section. For example, the flow regulator 25 can regulate, through the flow regulating mechanism 30, the flow rate of the fluid circulating through each of the sections in the fuel cell stack 10.

### <Method of State Management in Fuel Cell System>

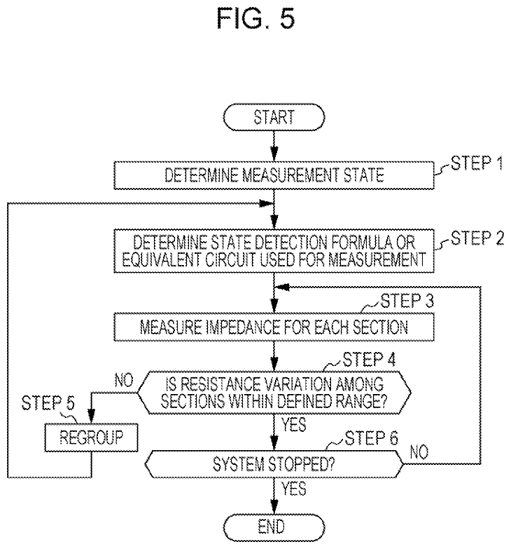

With also reference to FIG. 5, a method of state management in the fuel cell system 100 of the present embodiment will be described.

As illustrated in FIG. 5, the measurement state determiner 21 of the control device 20 first determines, in STEP 1, the number of sections to be subjected to measurement in the fuel cell stack 10. In the present embodiment, as illustrated in FIG. 4, a stack of five cells 1 is defined as one section. This enables the control device 20 to manage the state of each section constituted by the five cells 1.

The measurement state determiner 21 divides the fuel cell stack 10, as illustrated in FIG. 6, in such a way that the number of cells (15 in this example) constituting the middle section (section SCk) in the middle of the fuel cell stack 10 and the number of cells (10 in this example) constituting each of the end sections (sections SC1 and SCn) on both sides of the middle section differ from each other. For convenience in explanation, FIG. 6 does not illustrate the air exhaust pipe 56 and a cooling water passage coupled to the fuel cell stack 10.

In STEP 2, in accordance with the state of measurement determined for each section of the fuel cell stack 10, the measurement state determiner 21 of the control device 20 determines the measurement frequency and amplitude of impedance, an analysis formula, an equivalent circuit, or measurement conditions by using a known technique. In other words, the measurement frequency and amplitude of impedance and the analysis formula different from those applied to the middle section (section SCk) in the middle of the fuel cell stack 10 are applied to the end sections (sections SC1 and SCn) on both sides of the middle section.

In STEP 3, the cell state detector 22 receives measurement information from the sensors 40, such as the voltage sensor 41 and others, and measures the cell state (including impedance) of each section constituting the fuel cell stack 10.

In STEP 4, on the basis of the impedance of each section detected in STEP 3, the cell state detector 22 determines whether resistance variation among sections is within a defined range. The method of measuring the impedance of each section is not particularly limited. For example, the impedance of each section may be calculated by using a known alternating-current impedance method described in JP-A No. 2017-201627 and JP-A No. 2020-198208.

For the “resistance variation”, an appropriate range for the specification of the cell 1 to be used may be determined in advance by experiment or simulation and set as the defined range, described above.

If the resistance variation among sections is within the defined range in STEP 4 (YES in STEP 4), a determination is made in STEP 6 as to whether the FCV system has stopped. If the vehicle system is still in operation, the process returns to STEP 3, from which the process described above continues.

If the resistance variation among sections is not within the defined range in STEP 4 (NO in STEP 4), the sections are regrouped in STEP 5.

That is, in STEP 5, the environmental information detector 23 first acquires environmental information around the FCV, such as the temperature and humidity around the fuel cell stack 10, on the basis of known measurement sensors (sensors 40) mounted on the FCV.

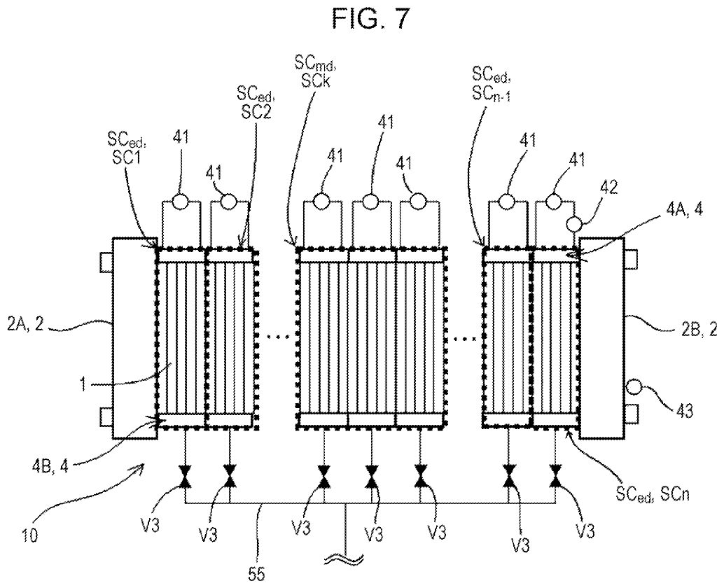

Then in STEP 5, for example, on the basis of the environmental information acquired by the environmental information detector 23, the grouping adjuster 24 performs regrouping in such a way that the number of cells constituting a section SC_{ed} at an end of the fuel cell stack 10 is reduced. That is, as can be understood from comparison between FIG. 6 and FIG. 7, the section SC1 originally constituted by ten cells 1 (see FIG. 6) is divided into the section SC1 and the section SC2, each constituted by five cells 1, after regrouping (see FIG. 7).

The detection of environmental information, made by the environmental information detector 23, may be skipped, as it is not always necessary for grouping or regrouping. When the detection of environmental information is skipped, the grouping or regrouping may be performed by referring to a region with significant temperature changes, determined in advance by experiment or simulation.

By performing finer regrouping on a region with significant temperature changes, such as a region at an end of the fuel cell stack 10, it is possible to achieve better state management than before the regrouping. The fuel cell system 100 of the present embodiment may thus further include a measurement sensor configured to measure one or both of the surrounding environment and the internal state of the fuel cell stack 10, and the control device 20 may have the function of regrouping the multiple sections, on the basis of the result of the measurement made by the measurement sensor, in such a way that the number of cells in the first section and the number of cells in the second section differ from each other.

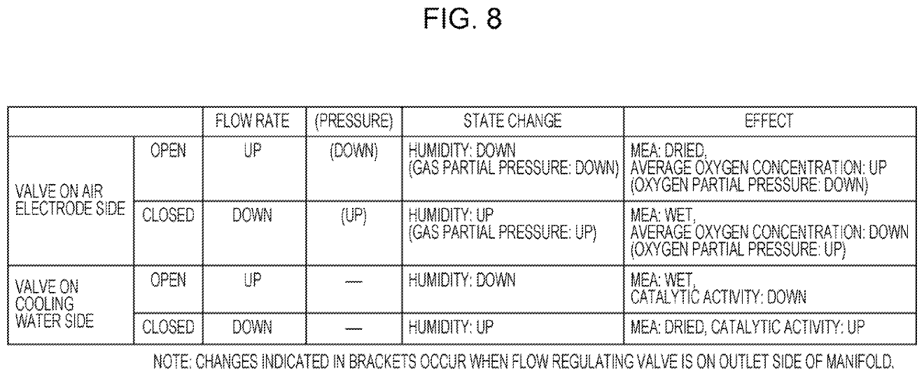

In STEP 5, on the basis of the regrouped state, the flow regulator 25 regulates the flow rate of a fluid flowing through each of the sections adjusted by the grouping adjuster 24. For example, as illustrated in FIG. 8, the flow regulator 25 regulates the flow rate of a fluid through the flow regulating mechanism 30, in such a way as to improve the state of each cell 1 on the basis of the state of cells 1 in each section.

For example, if the cells 1 in a section (e.g., section SC1) are determined to be in a dried state, the flow regulator 25 may reduce the flow rate of oxidation gas or may increase the flow rate of cooling water in the section SC1, through the flow regulating mechanism 30. Bringing the section SC1 into a wet state will have an impact on another section (e.g., adjacent section SC2).

Therefore, if the flow regulator 25 determines that the cells 1 in one section exhibit a flooding tendency as a result of the flow regulation in another section, for example, the flow regulator 25 may reduce the flow rate of cooling water in the one section through the flow regulating mechanism 30.

As described above, when regulating the flow rate of the fluid in the first section (or section SC1 in the example described above) of multiple sections through the flow regulating mechanism 30, the flow regulator 25 of the present embodiment may regulate the flow rate in the second section (or section SC2 in the example described above) of the multiple sections, in accordance with the flow regulation in the first section.

### Second Embodiment

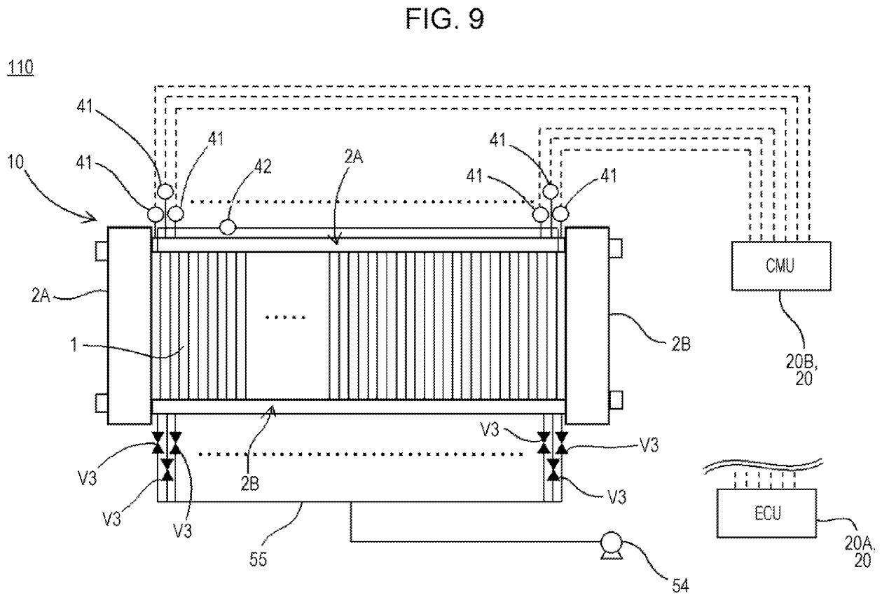

A fuel cell system 110 of a second embodiment will now be described with reference to FIG. 9.

In the fuel cell system 100 of the first embodiment, one section is constituted by at least five cells 1.

In contrast, the fuel cell system 110 of the present embodiment is characterized in that each of the cells 1 constituting the fuel cell stack 10 is capable of measuring, for example, the state of voltage or current, and regulating the flow rate of any of the fluids (oxidation gas, fuel gas, and cooling water) flowing in the cell 1.

In the following description, components having the same functions as those described above are denoted by the same reference numerals and their description will be omitted where appropriate.

In the fuel cell system 110 of the second embodiment, as illustrated in FIG. 9, the cells 1 constituting the fuel cell stack 10 are each provided with the voltage sensor 41, which is capable of detecting the voltage of the cell 1. Also, in the fuel cell system 110 of the second embodiment, the passages in the first manifold 3 and the second manifold 4 each correspond to one cell 1, and the flow regulating mechanism 30 is capable of regulating the flow rate of the fluid for each cell 1.

Also, in the fuel cell system 110 of the second embodiment, the control device 20 can set the number of cells 1 in each section of the fuel cell stack 10 constituted by multiple cells 1 to any value. For example, the control device 20 may determine that the section SC1 at an end of the fuel cell stack 10 is to be constituted by three cells 1, and that the section SCk in the middle of the fuel cell stack 10 is to be constituted by six cells 1. In this case, the control device 20 can control multiple flow regulating valves V3 belonging to the same section in such a way that the flow regulating valves V3 open and close in a synchronized manner.

As described above, the control device 20 of the fuel cell system 110 can divide the fuel cell stack 10 into any number of sections, and can set the number of cells 1 constituting each section to any value. Additionally, the control device 20 of the fuel cell system 110 can regroup the existing sections (in STEP 5) into any number of sections and reset the number of cells in each section to any value. The control device 20 can thus appropriately divide the fuel cell stack 10 into sections and set the number of cells 1 in each section, in accordance with changes in the state and environmental information of the fuel cell stack 10.

In the fuel cell systems according to the embodiments of the present disclosure, the fuel cell stack of multiple cells is divided into any number of sections, whose states are individually managed. Also, the number of cells in one section differs from that in another section. This can effectively prevent a partial degradation of cell performance and quality.

The embodiments described above are examples of the present disclosure. Without departing from the scope of the present disclosure, elements of the embodiments may be appropriately combined to provide new structures or control. A modification applicable to the embodiments will now be described.

### <Modification>

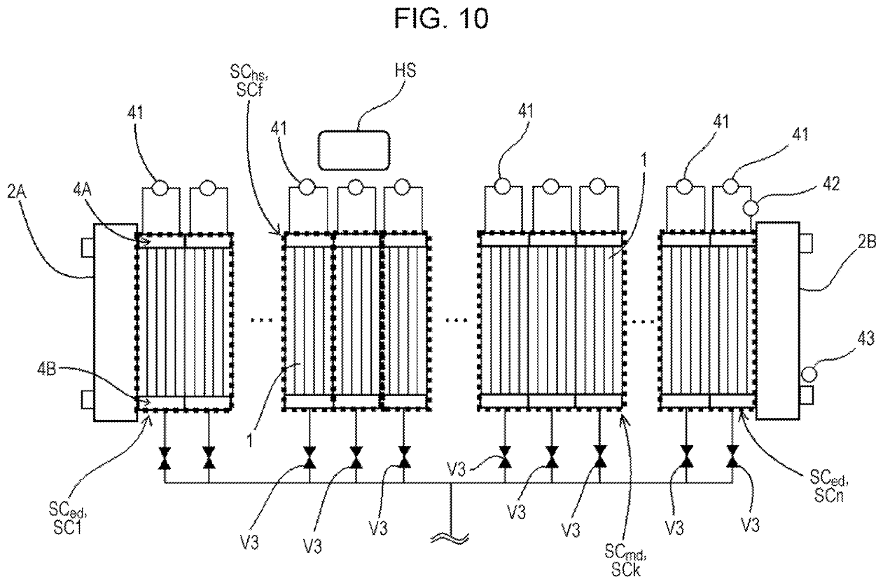

FIG. 10 illustrates a modification of the fuel cell systems according to the embodiments described above.

As illustrated in FIG. 10, a heat source HS is disposed around the fuel cell stack 10. Examples of the heat source HS include various known heat sources, such as an inverter in the FCV and the DC-to-DC converter described above.

As illustrated in FIG. 10, the fuel cell stack 10 of the present modification includes a section SCₕₛ close to the heat source HS, and other sections (e.g., sections SC1 and SCn which are sections SC_{ed} at ends of the fuel cell stack 10 in the present example) not significantly affected by heat from the heat source HS. Therefore, the grouping adjuster 24 of the control device 20 may perform grouping or regrouping in such a way that the section SCₕₛ of the fuel cell stack 10 close to the heat source HS is constituted by fewer cells, as illustrated in FIG. 10.

As can be understood from FIG. 10, the grouping adjuster 24 of the control device 20 may set the number of cells (5 in this example) constituting the section SCₕₛ close to the heat source HS to be less than the number of cells (15 in this example) constituting a section SC_{md} in the middle of the fuel cell stack 10 and the number of cells (10 in this example) constituting the section SC_{ed} at an end of the fuel cell stack 10.

As described above, the control device 20 may perform grouping in such a way that a region with significant temperature changes, such as a region at an end of the fuel cell stack 10 or near the heat source HS, is constituted by fewer cells than in other regions. Examples of the “region with significant temperature changes” include a region near a cooling air duct, a region prone to coming into contact with moisture, such as rainwater, and a region near the compressor, as well as an end region and a region near the heat source, described above.

When performing the grouping described above, the control device 20 may gradually change the number of cells constituting each section of the fuel cell stack 10 in accordance with the distance from the heat source. For example, the control device 20 may perform grouping in such a way that sections near the heat source are each constituted by fewer cells and the number of cells constituting each section is gradually increased with increasing distance from the heat source.

In the fuel cell system according to the modification, the state of cells in a region susceptible to heat from the heat source disposed around the fuel cell system can be finely managed. This can further reduce partial degradation of cell performance and quality.

While embodiments and modifications of the present disclosure have been described in detail with reference to the accompanying drawings, the present disclosure is not limited to such examples. It is obvious that a person with ordinary knowledge in the technical field to which the present disclosure pertains can try to make further changes to the embodiments and modifications within the technical ideas set forth in the claims, and it is to be understood that these changes also pertain to the technical scope of the present disclosure.

1. A fuel cell system comprising:
a fuel cell stack divided into multiple sections, each of the multiple sections being constituted by one or more cells;
a control device configured to manage a state of the one or more cells for each of the multiple sections; and
a flow regulating mechanism configured to regulate a flow rate of a fluid circulating through each of the multiple sections, based on the state managed by the control device,
wherein the control device is configured to divide the fuel cell stack such that a number of cells in a first section of the multiple sections and a number of cells in a second section of the multiple sections other than the first section differ from each other.

2. The fuel cell system according to claim 1, wherein the control device is configured to divide the fuel cell stack such that a number of cells constituting a middle section of the fuel cell stack and the number of cells constituting an end section of the fuel cell stack differ from each other, the middle section being located in a middle of the fuel cell stack, the end section being located closer to an end of the fuel cell stack than the middle section is.

3. The fuel cell system according to claim 1, wherein the fuel cell stack is divided such that a number of cells constituting an end section of the fuel cell stack is smaller than a number of cells constituting a middle section of the fuel cell stack, the middle section being located in a middle of the fuel cell stack, the end section being located closer to an end of the fuel cell stack than the middle section is.

4. The fuel cell system according to claim 1, further comprising a measurement sensor configured to make a measurement of one or both of a surrounding environment of the fuel cell stack and an internal state of the fuel cell stack,
wherein the control device is configured to, based on a result of the measurement made by the measurement sensor, regroup the multiple sections such that the number of cells in the first section and the number of cells in the second section differ from each other.

5. The fuel cell system according to claim 1, wherein the flow regulating mechanism is configured to, upon regulating a flow rate of a fluid in the first section, regulate a flow rate in the second section in accordance with the flow regulation in the first section.

6. The fuel cell system according to claim 2, wherein the flow regulating mechanism is configured to, upon regulating a flow rate of a fluid in the first section, regulate a flow rate in the second section in accordance with the flow regulation in the first section.

7. The fuel cell system according to claim 3, wherein the flow regulating mechanism is configured to, upon regulating a flow rate of a fluid in the first section, regulate a flow rate in the second section in accordance with the flow regulation in the first section.

8. The fuel cell system according to claim 4, wherein the flow regulating mechanism is configured to, upon regulating a flow rate of a fluid in the first section, regulate a flow rate in the second section in accordance with the flow regulation in the first section.

9. A fuel cell system comprising:
a fuel cell stack divided into multiple sections, each of the multiple sections being constituted by one or more cells;
circuitry to manage a state of the one or more cells for each of the multiple sections; and
a flow regulating mechanism including a flow regulating valve and configured to regulate a flow rate of a fluid circulating through each of the multiple sections, based on the state managed by the circuitry,
wherein the circuitry is configured to divide the fuel cell stack such that a number of cells in a first section of the multiple sections and a number of cells in a second section of the multiple sections other than the first section differ from each other.
